(19) United States
(12) Patent Application Publication
(10) Pub. No.: US 2008/0152160 A1
(43) Pub. Date: Jun. 26, 2008

(54) Methods and apparatus for wireless stereo audio

(76) Inventors: Kok-Kia Chew, Fremont, CA (US); Tianbing Gong, Fremont, CA (US); Hsu-Kuang Liou, San Jose, CA (US)

Correspondence Address: OKAMOTO & BENEDICTO, LLP, P.O. BOX 641330, SAN JOSE, CA, 95164, US

(21) Appl. No.: 11/998,562

(22) Filed: Nov. 30, 2007

Related U.S. Application Data
(60) Provisional application No. 60/872,217, filed on Dec. 1, 2006.

(51) Int. Cl. G10K 11/16; H04R 1/10; H04M 1/00; H04H 20/71

(52) U.S. Cl. 381/71.6; 381/77; 381/370; 455/569.1

(57) ABSTRACT

One aspect disclosed herein pertains to wireless audio transmission to a series of headset receivers in a daisy chain. Another aspect relates to a wireless headset with integrated audio outputs so that amplified audio may be made available to one or more persons without the use of head-phone or ear-bud listening devices. Another aspect pertains to a wireless headset with an integrated mini-loudspeaker for incoming cell phone calls. Another aspect relates to a wireless headset with both noise cancellation and external voice enhancement features. Yet another aspect relates to a wireless device configured to receive an audio or voice signal and to re-transmit the signal. Other aspects, features and embodiments are also disclosed herein.

### CROSS-REFERENCE TO RELATED APPLICATION

This application claims the benefit of U.S. Provisional Application No. 60/872,217, entitled “Methods and Apparatus for Wireless Stereo Audio,” filed by Kok-Kia Chew, Tianbing Gong, and Hsu-Kuang Liou on Dec. 1, 2006, which is incorporated herein by reference in its entirety.

### BACKGROUND OF THE INVENTION

1. Field of the Invention

The present invention relates generally to wireless audio technologies.

2. Description of the Background Art

Wireless electronic products provide users with tremendous freedom. In recent years, there has been rapid progress in short-range wireless data communications. One example of such a short-range wireless technology is Bluetooth™ technology.

For example, Bluetooth™ technology enables headphones to wirelessly receive an audio signal from an audio signal source without a wire-line connection to the audio signal source. This allows the user to move around freely within a range of the audio signal source and still enjoy the audio programming being provided through the headphones.

In a typical embodiment of Bluetooth™ wireless stereo, a Bluetooth™ transmitter (TX) device 104 is attached to an audio source 102 (as shown in FIG. 1) or integrated in an audio source 202 (as shown in FIG. 2), accepting or originating either analog audio (through an audio plug) or digital audio through standard digital interfaces (PCM, I2S, SPDIF or USB) and then transmitting (106 or 206) the audio information wirelessly. The audio information is then received 308 to another Bluetooth™ wireless receiver (RX) device 310 (as shown in FIG. 3). Audio sources include mobile entertainment devices like iPod/MP3 devices, personal computer systems or home audio/CD/DVD/TV entertainment systems. The transmitted audio is then received 308 by a sink or receiving (RX) Bluetooth™ device 310 and fed to audio speakers (mono-sets, stereo head-sets, ear-buds, external speakers).

### BRIEF DESCRIPTION OF THE DRAWINGS

FIG. 1 is a schematic diagram showing conventional audio sources and separate wireless transmitters.

FIG. 2 is a schematic diagram showing conventional audio sources with integrated wireless transmitters.

FIG. 3 is a schematic diagram showing conventional wireless receivers.

FIG. 4A is a schematic diagram showing conventional wireless audio transmission to a single headset receiver.

FIG. 4B is a schematic diagram showing conventional wireless audio broadcasting to multiple headset receivers.

FIG. 5 is a schematic diagram showing wireless audio transmission to a daisy chain of headset receivers in accordance with an embodiment of the invention.

FIG. 6 is a schematic diagram of a conventional wireless headset receiver.

FIG. 7A is a schematic diagram of a wireless headset receiver in accordance with an embodiment of the invention.

FIG. 7B is another schematic diagram of a wireless headset receiver (similar to FIG. 7A) which shows left and right circuit modules in accordance with an embodiment of the invention.

FIG. 7C is a pin-out diagram indicating signals corresponding to the various pins of the circuit module (either right or left) in FIG. 7B in accordance with an embodiment of the invention.

FIG. 7D is an image of a BTMM5C2 module from Windigo Systems of San Jose, Calif. The BTMM5C2 is an implementation of the circuit module shown in FIGS. 7B and 7C.

FIG. 8 is a schematic diagram of a wireless headset receiver including optional audio outputs in accordance with an embodiment of the invention.

FIG. 9 is a schematic diagram of a wireless headset receiver including an optional ring-tone/buzz feature in accordance with an embodiment of the invention.

FIG. 10 is a schematic diagram of headset circuitry for providing a combined noise cancellation and voice enhancement pass-through feature in accordance with an embodiment of the invention.

FIG. 11 depicts a wireless device in accordance with an embodiment of the invention.

FIG. 12A depicts a wireless device functioning as a wireless receiver in accordance with an embodiment of the invention.

FIG. 12B depicts a wireless device functioning as a wireless transmitter in accordance with an embodiment of the invention.

FIG. 12C depicts a wireless device functioning as a non-wireless audio pass-through device in accordance with an embodiment of the invention.

FIG. 12D depicts a wireless device functioning to receive wireless audio and re-transmit the audio signal to another wireless device in accordance with an embodiment of the invention.

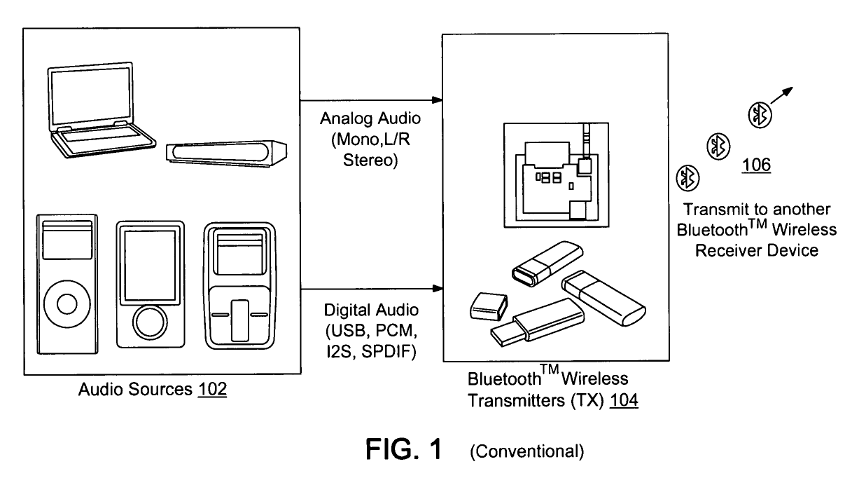

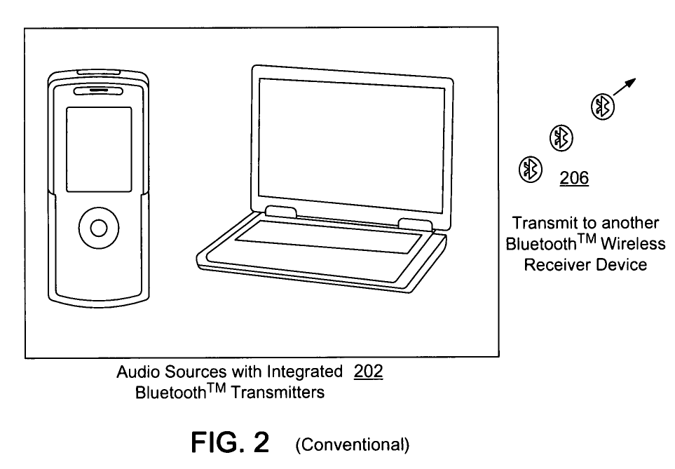

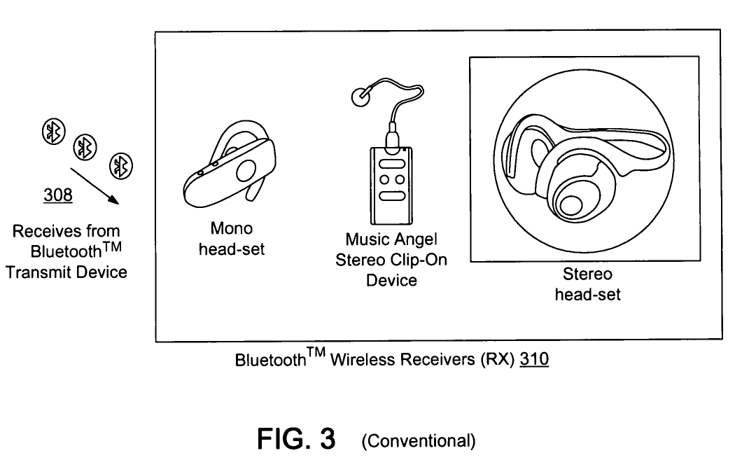

### SUMMARY

One aspect disclosed herein pertains to wireless audio transmission to a series of headset receivers in a daisy chain. Another aspect relates to a wireless headset with integrated audio outputs so that amplified audio may be made available to one or more persons without the use of head-phone or ear-bud listening devices. Another aspect pertains to a wireless headset with an integrated mini-loudspeaker for incoming cell phone calls. Another aspect relates to a wireless headset with both noise cancellation and external voice enhancement features. Yet another aspect relates to a wireless device configured to receive an audio or voice signal and to re-transmit the signal. Other aspects, features and embodiments are also disclosed herein.

### DETAILED DESCRIPTION

### Wireless Audio Transmission to Multiple Receivers

It is highly desirable to improve wireless audio technologies. In particular, for example, current broadcast implementations for wireless audio are not reliable and typically lead to poor audio quality. Hence, what is desired in regards to broadcast implementations is to be able to transmit wireless audio to multiple receivers with improved reliability.

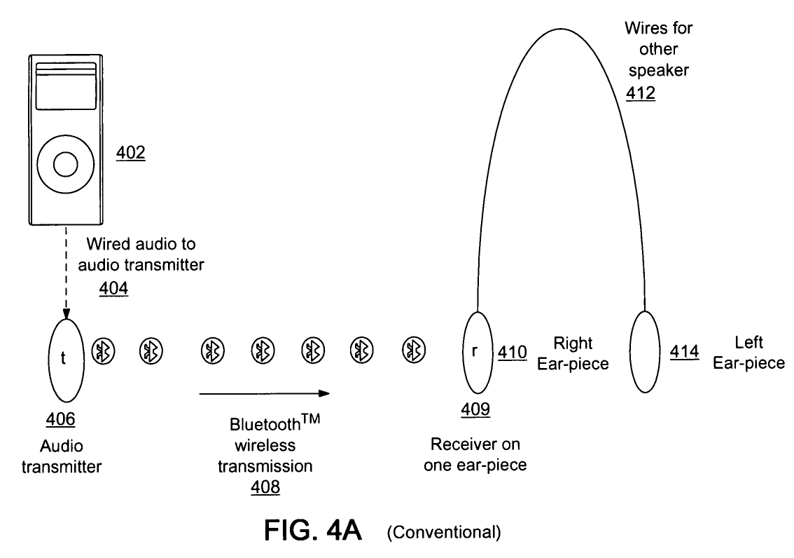

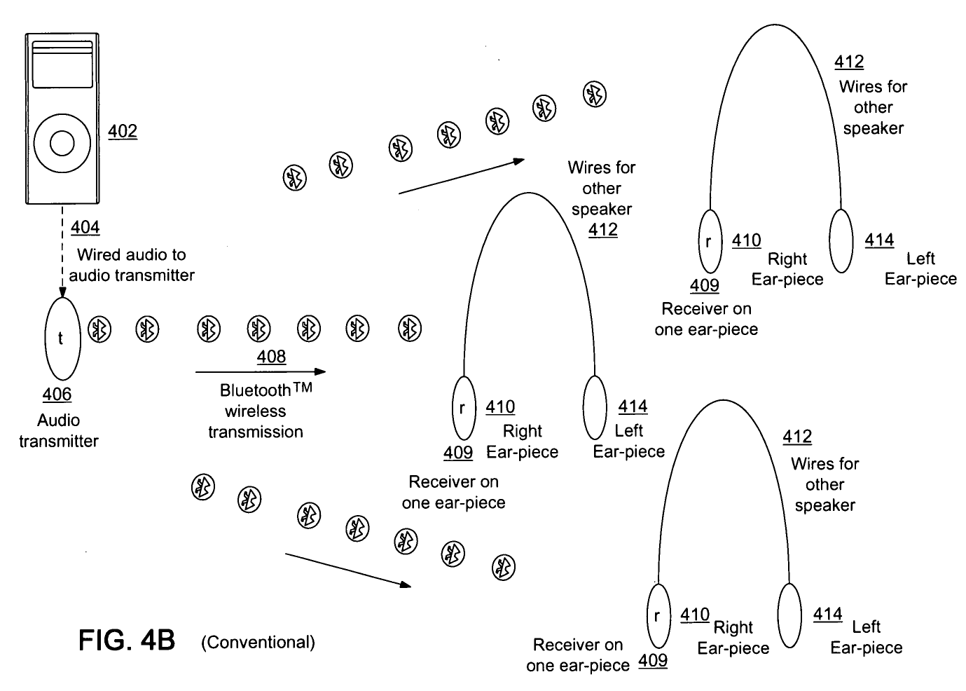

FIG. 4A is a schematic diagram showing conventional wireless audio transmission to a headset receiver. In a typical wireless stereo headset, an audio wireless transmitter 406 is connected through wires/connector/audio-plug 404 to the audio output of an audio device 402 and audio is then transmitted 408 to a paired wireless stereo headset receiver. A wireless receiver 409 is embedded within the paired stereo receiver, such as the headset shown. The wireless receiver 409 is typically embedded in one of the ear pieces 410. The example shown has the wireless receiver 409 embedded in the right ear-piece. Wires 412 are used to communicate an audio signal to the other ear piece 414.

FIG. 4B is a schematic diagram showing conventional wireless audio broadcasting to multiple headset receivers. Here, the wireless transmission 408 from the audio transmitter 406 is depicted as being broadcast such that it is received by multiple headset receivers.

Unfortunately, the conventional Bluetooth™ broadcast scheme illustrated in FIG. 4B is not very robust and typically results in poor audio quality. In particular, under Bluetooth™, broadcast ACL (asynchronous connectionless) packets are not acknowledged by the receiving end. In other words, when the wireless transmitter is broadcast transmitting ACL packets, there is no guarantee that a packet has been received by each of the multiple receiving devices. Under Bluetooth™, each broadcast packet may be transmitted a fixed number of times before the next broadcast packet of the same broadcast message is transmitted. However, this does not guarantee timely reception by each of the multiple receivers. Moreover, time-critical broadcast information may abort the ongoing broadcast.

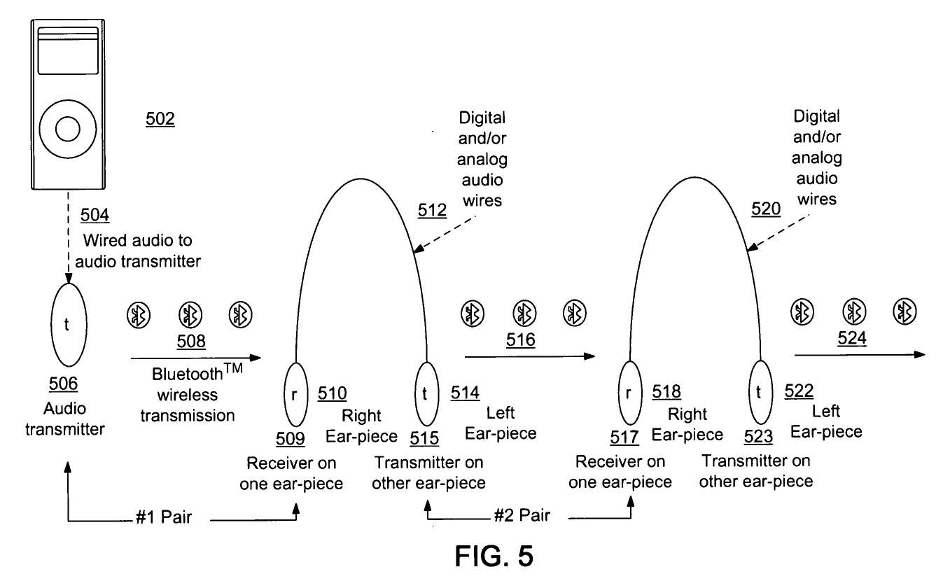

In contrast to the conventional wireless audio broadcast shown in FIG. 4B, FIG. 5 is a schematic diagram showing wireless audio transmission to a daisy chain of headset receivers in accordance with an embodiment of the invention. This system architecture for wireless audio transmission to a series of headset receivers provides more reliable “broadcasting” by enabling each wireless transmitter to send the packet stream to a single, addressed wireless receiver which is the next device in the daisy chain. It further enables each wireless receiver to send a packet received acknowledgement to the sending wireless transmitter which is the preceding device in the daisy chain.

As shown in FIG. 5, a first or initial audio wireless transmitter 506 is connected through wires/connector/audio-plug 504 to the audio output of an audio device 502. Here, audio packets are transmitted 508 to a single, addressed receiver 509 on a first headset. The wireless receiver 509 may be embedded in one of the ear pieces 510 of the first headset. The example shown has the wireless receiver 509 embedded in the right ear-piece. Digital and/or analog audio wires 512 may be used to communicate audio signals to the other ear piece 514. The first audio wireless transmitter 506 and the first audio wireless receiver 509 may be considered as a first audio wireless transmitter/receiver pair (#1 Pair).

Unlike in a conventional headset design, the other ear piece 514 includes a wireless audio transmitter 515. This wireless audio transmitter 515 may be configured to re-transmit 516 the audio packets to a single, addressed receiver 517 on a second headset. The wireless receiver 517 may be embedded in one of the ear pieces 518 of the second headset. The example shown has the wireless receiver 517 embedded in the right ear-piece. Digital and/or analog audio wires 520 may be used to communicate audio signals to the other ear piece 522. The second audio wireless transmitter 515 and the second audio wireless receiver 517 may be considered as a second audio wireless transmitter/receiver pair (#2 Pair).

Here, again, the other ear piece 522 may include a wireless audio transmitter 523. This wireless audio transmitter 523 may be configured to re-transmit 524 the audio packets to a single, addressed receiver on a third headset. And so on. In accordance with a method and apparatus of the present disclosure, this process and structure may be repeated to form a series of daisy chain links, where each link corresponds to an audio wireless transmitter receiver pair.

The system architecture depicted in FIG. 5 for wireless audio transmission to a series of headset receivers provides a more reliable “broadcasting” technique. The architecture enables each wireless transmitter to send the packet stream to a single, addressed wireless receiver which is the next device in the daisy chain. Moreover, each wireless receiver is enabled to send a packet received acknowledgement to the sending wireless transmitter which is the preceding device in the daisy chain.

The present application discloses differences between conventional wireless headsets and wireless headset designs in accordance with various embodiments of the invention.

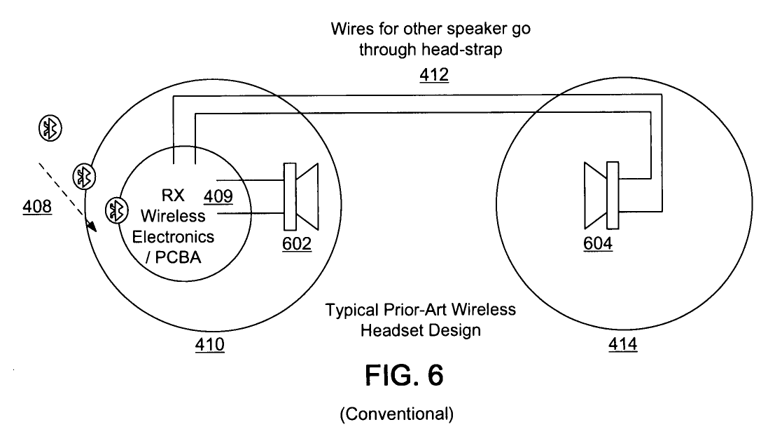

A typical conventional wireless headset receiver is shown in FIG. 6. As shown, a typical conventional wireless headset design has the wireless receiver electronics 409 embedded within one of the two ear-pieces. The electronics 409 drive two speakers, one speaker 602 connected within same the ear-piece 410 as resides the electronics 409, and the other speaker 604 in another ear-piece 414 connected to the electronics 409 via wires 412 that are supported by and part of the headset head strap.

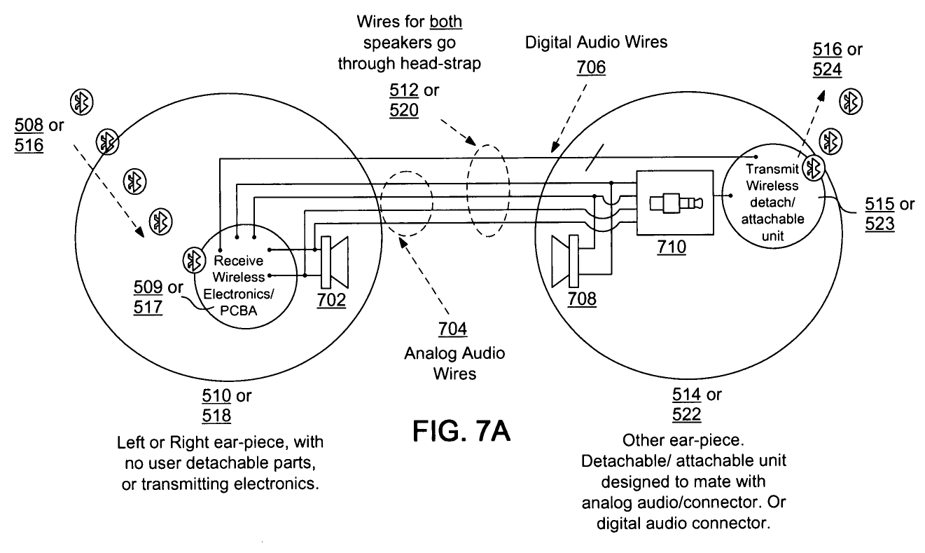

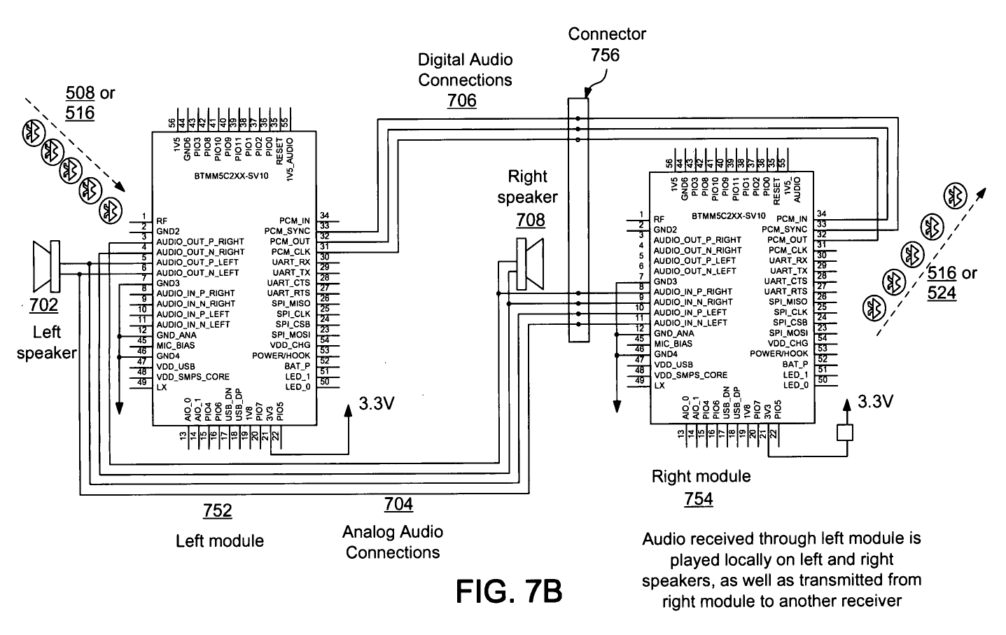

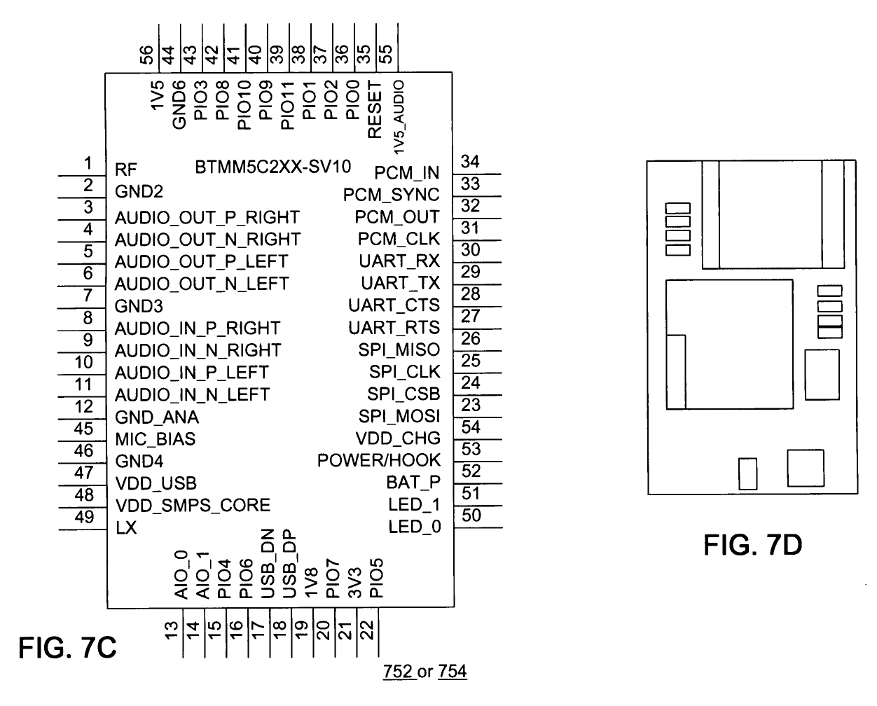

In contrast to FIG. 6, a schematic diagram of a wireless headset receiver in accordance with an embodiment of the invention is shown in FIG. 7A. As shown in FIG. 7A, the two speakers 702 and 708 (one in each ear-piece) may be driven by the receive electronics (509 or 517). Analog audio wires 704 (including the two additional wires shown from the input to the first speaker 702) and/or digital audio wires 706 may be passed through the head-strap which connects the two ear-pieces so as to feed the audio wireless transmitter (515 or 523). Note that stereo audio signals for both the left and right sides of the headset pass through the head-strap so as to be provided to the audio wireless transmitter (515 or 523)

In accordance with an embodiment of the invention, the ear-piece (514 or 522) with the transmitter (515 or 523) therein may be configured so as to be detachable from the headset. The detachable ear-piece may include a connector 710 (either an analog audio connector or a digital audio connector). When detached, the ear-piece may be utilized as an initial wireless transmitter by plugging the connector 710 into an audio output jack of a stereo system or other audio source device. This dual usage of the transmitter ear-piece is an advantageous feature of this embodiment.

FIG. 7B is another schematic diagram of a wireless headset receiver (similar to FIG. 7A) which shows left 752 and right 754 circuit modules in accordance with an embodiment of the invention. As shown in FIG. 7B, the two speakers 702 and 708 (one in each ear-piece) may be driven by the receive electronics in the left module 752. Analog audio wires or connections 704 (including the two additional wires shown from the input to the first speaker 702) and/or digital audio wires or connections 706 may be passed through the head-strap which connects the two ear-pieces so as to feed the audio wireless transmitter in the right module 754. Note that stereo audio signals for both the left and right sides of the headset pass through the head-strap so as to be provided to the audio wireless transmitter in the right module 754.

In accordance with an embodiment of the invention, the ear-piece (514 or 522) with the right module 754 therein may be configured so as to be detachable from the headset. The detachable ear-piece may include a connector or connectors 756 for analog audio connections 704 and digital audio connections 706. When detached, the ear-piece may be utilized as an initial wireless transmitter by plugging the connector 756 into an audio output jack of an audio source device. This dual usage of the transmitter ear-piece is an advantageous feature of this embodiment.

FIG. 7C is a pin-out diagram indicating signals corresponding to the various pins of the circuit module (either left 752 or right 754) in FIG. 7B in accordance with an embodiment of the invention. As seen, pin numbers 3 (AUDIO_OUT_P_RIGHT), 4 (AUDIO_OUT_N_RIGHT), 5 (AUDIO_OUT_P_LEFT), and 6 (AUDIO_OUT_N_LEFT) provide the analog audio signals, while pin numbers 31 (PCM_CLK), 32 (PCM_OUT), and 33 (PCM_SYNC) provide the digital audio signals.

FIG. 7D is an image of a BTMM5C2 module from Windigo Systems of San Jose, Calif. The BTMM5C2 is an implementation of the circuit module shown in FIGS. 7B and 7C.

In accordance with an alternate embodiment, the transmitting electronics (515 or 523) may be located on a same side of the headset as the receiver electronics (509 or 517). In that case, the connecting digital/analog audio wires would be re-located accordingly to within the ear-piece.

Advantageously, propagating audio signals by way of the above-discussed wireless daisy-chain propagation method (in which the wireless audio signal is received then transmitted by a series of devices) results in no loss audio quality. This is because audio quality is preserved at each wireless device in the digital daisy chaining.

While a preferred embodiment of the invention utilizes the wireless daisy-chain propagation method to propagate audio signals via wireless head-set devices, other embodiments may utilize the wireless daisy chain propagation method to propagate audio signals or other data signals from one Bluetooth device (or other wireless device) to another.

### Integrated Audio Outputs in Wireless Headset

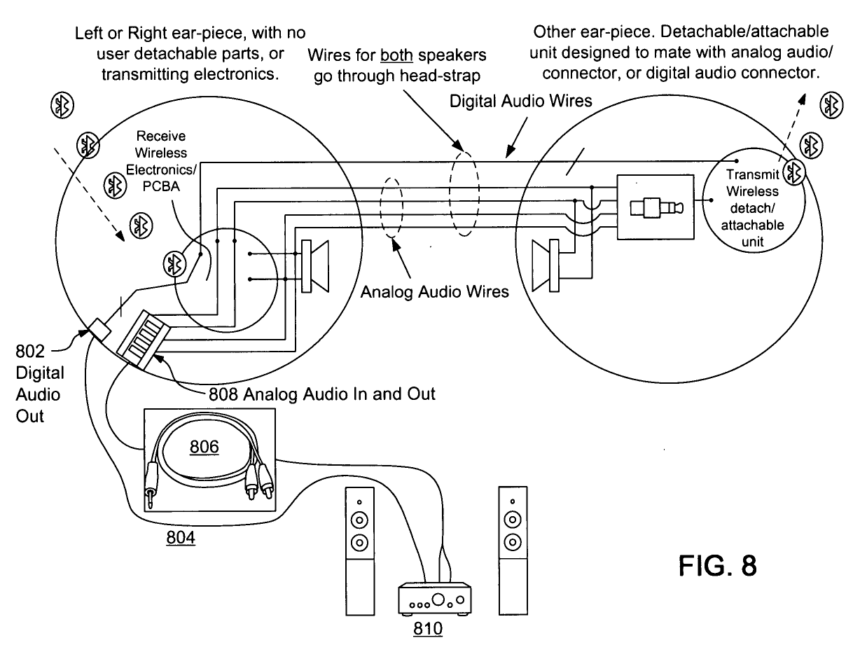

FIG. 8 is a schematic diagram of a wireless headset receiver including optional audio outputs in accordance with an embodiment of the invention. The optional audio outputs shown include a digital audio output 802 and an analog audio input and output 808. The digital audio output 802 may be connected via a digital audio wire 804 to a stereo system or other audio device 810. Similarly, the analog audio input or output 808 may be connected via analog audio wires 806 to a stereo system or other audio device 810.

The analog audio input (808) enables the headset to be used as a wired headset if the user desires to connect it to an audio output of a stereo system or other audio device 810. This dual usage of the headset as a wired or wireless headset is an advantageous feature of this embodiment.

Furthermore, the audio outputs (802 and/or 808) enable the headset to be utilized as an audio source by connecting it to an audio input of a stereo system or other audio device 810. This alternate usage of the headset as an audio source is a further advantageous feature of this embodiment. For example, wirelessly received digital and/or analog audio may then be made available to another wired audio amplifier/speaker system so that amplified audio may be made available to one or more persons without the use of head-phone or ear-bud listening devices.

### Integrated Mini-Loudspeaker in Wireless Headset for Incoming Cell Phone Calls

In relation to another aspect, Bluetooth™ stereo audio receiver devices may also receive cell phone calls, if the device is paired with a cell phone that has a Bluetooth™ transmitter. For example, while listening with the head-set to audio, if a cell phone call arrives, the person listening to the audio with the head-set may be alerted to the incoming call through a ringing sound in the conventional speakers 602 and 604 in the ear pieces of the headset. The user may then transfer from listening to audio to cell-phone conversation through a microphone (not shown) attached to one of the ear pieces (and vice-versa) with a button (not shown) on the ear-piece. The cell phone may be located some distance away from the headset (for example, up to 10 meters under Class II, and up to 100 meters under Class I), and the person may still use the stereo headset for cell-phone calls.

Unfortunately, a problem arises when both the cell phone is located far away from the user, and the user is not wearing the headset (i.e. does not have the ear pieces close to his or her ears. In such situations, the user is unlikely to hear the ringing sound from the ear pieces, and hence may miss picking up any incoming calls. This is due to the relatively low audio volume emanating from the ear-piece speakers (so as not to damage hearing, for example).

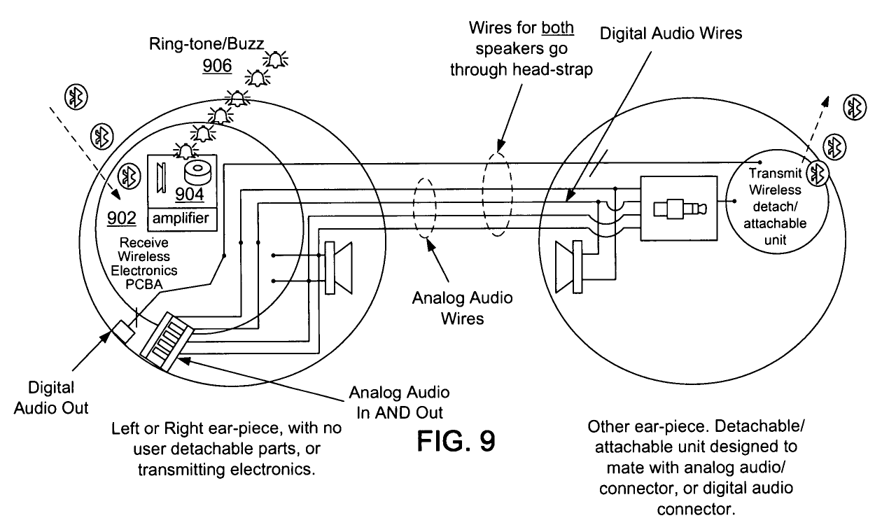

In accordance with an embodiment of the invention, such a problematic situation may be solved using a wireless headset receiver such as that shown in FIG. 9. As shown in FIG. 9, the headset may include an amplifier 902 coupled to the wireless receiver electronics (509 or 517) and a tiny loudspeaker or micro-speaker 904 configured to be able to generate a loud audible buzz or ring tone 906.

Using such a headset as shown in FIG. 9, if a cell phone call arrives, the circuitry of the headset is configured to produce with a loud audible buzz or ring tone 906 which comes from the micro-speaker 904 in the headset. This may alert the cell phone user or a bystander that a call is available on the stereo headset, even when the headset's ear-pieces are not in close proximity to a person's ears.

### Combined Noise Cancellation and External Voice Enhancement

When hearing music through a stereo headset or ear-buds, external noise is often coupled with the music into the ears, contaminating the fidelity of music, especially in noisy environments like in an airplane, train, bus and other noisy environments. Moreover, another person trying to converse with the person wearing the headset/ear-buds would have the voice muffled by the ear-devices. The noise from the environment and the sound muffling are seemingly conflicting problems. However, applicants believe that it is desirable for a headset to have capability to both eliminate/reduce external noise and allow/enhance external voice to the ears while the headset/ear-buds are worn.

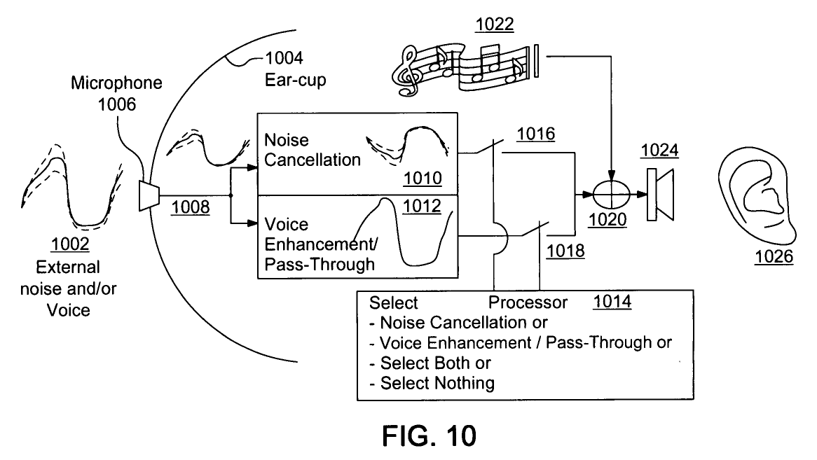

FIG. 10 is a schematic diagram of headset circuitry for providing a combined noise cancellation and voice enhancement pass-through feature in accordance with an embodiment of the invention. As shown, there may be both undesirable external noise and/or desirable external voice signals 1002 coming from outside the ear-cup 1004 of a headset.

In accordance with an embodiment of the invention, a microphone 1006 is configured on the ear-cup so as to pick-up the external noise and/or voice signals 1002. The microphone 1006 is electronically coupled so as to provide a signal 1008 to both noise cancellation circuitry 1010 and voice enhancement/pass-through circuitry 1012 in the headset. The noise cancellation circuitry 1010 may be configured to output a noise-cancellation audio signal 1016 which reduces the external noise heard by a user. On the other hand, the voice enhancement/pass-through circuitry 1012 may be configured to output a voice enhanced or voice pass-through signal 1018 which reduces the muffling of an external voice signal caused by the ear-cup 1004.

The signal output to the ear-piece speaker 1024 may be formed by signal combining circuitry 1020. The signal combining circuitry 1020 may receive as selectable (switchable on/off) inputs the following: the noise cancellation signal 1016, the voice enhanced or voice pass-through signal 1018, and the audio (for example, music) signal 1022.

A processor (for example, a DSP and/or RISC processor) 1014 may be configured with logic-based intelligence. The processor 1014 may select various speaker output modes depending on its configuration and the circumstances of the various signals. For example, the following modes may be selectable in accordance with an embodiment of the invention.

A first selectable mode may combine the audio signal 1022 with the noise cancellation signal 1016 for listening to music with minimal external noise.

A second selectable mode may combine the audio signal 1022 with the voice enhanced or voice pass-through signal 1018 so that the user may hear someone talking to him or her while still listening to music.

A third selectable mode may combine the audio signal 1022 with both the noise cancellation signal 1016 and the voice enhanced or voice pass-through signal 1018 so that the user may hear someone talking to him or her while listening to music with minimal external noise.

A fourth selectable mode may simply output the audio signal 1022 without noise cancellation or voice enhancement.

A fifth selectable mode may output only the noise cancellation signal 1016, without music or voice enhancement. This may be useful for peace and quiet or sleeping.

A sixth selectable mode may output only the voice enhancement signal 1018, without music or noise cancellation.

A seventh selectable mode may output the noise cancellation signal 1016 and the voice enhancement signal 1018, without music. This may be useful for conversing in a noisy environment.

An eighth mode may output no signal (no music, no noise cancellation, and no voice enhancement).

Furthermore, the above eight audio output modes may be applied with any of the following wireless/wired modes. First, wireless may be turned on. Second, wireless may be turned off, but the headset speakers may be driven by audio from an external audio source connected by wires. Third, both wired and wireless audio may be turned off.

### Wireless Device

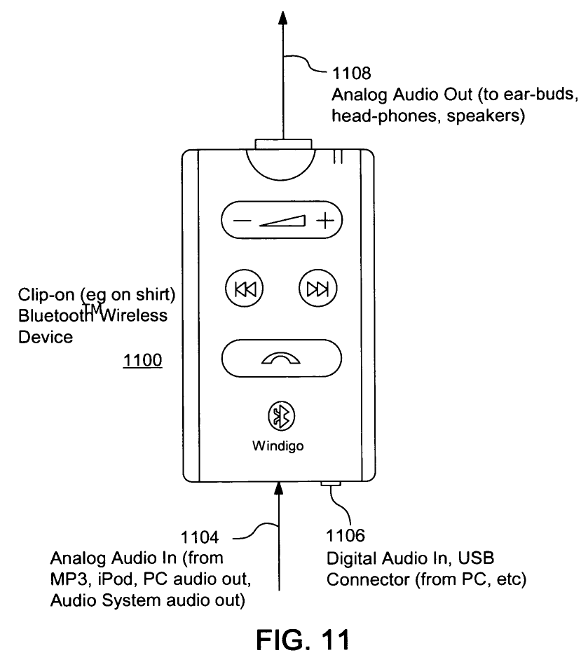

FIG. 11 depicts a clip-on wireless device 1100 in accordance with an embodiment of the invention. The wireless device 100 includes both a wireless receiver and a wireless transmitter. As indicated, the wireless device 1100 may also include a clip (on the backside (not illustrated) or other device to attach the device to a user's clothing (for example, a shirt, or a pocket).

The wireless device 1100 may include various user inputs as depicted. The user inputs may include, for example, a volume control (top user input in FIG. 11), reverse-to-previous and forward-to-next controls (middle buttons in FIG. 11), and an audio input selector (bottom button in FIG. 11). Other specific user inputs may be configured in alternate embodiments.

As shown, the wireless device 1100 may include an analog audio input port 1104, a digital audio input port 1106, and an analog audio output port 1108. The analog audio input signal 1104 may be received, for example, from an iPod™ or other MP3 player an audio output signal from a personal computer system, or an audio output signal from a stereo or other audio system. The digital audio input signal 1106 may be received, for example, from a USB connector from a personal computer or other electronic system. The analog audio output signal 1108 may be transmitted to head-phones, or ear-buds, or speakers, for example.

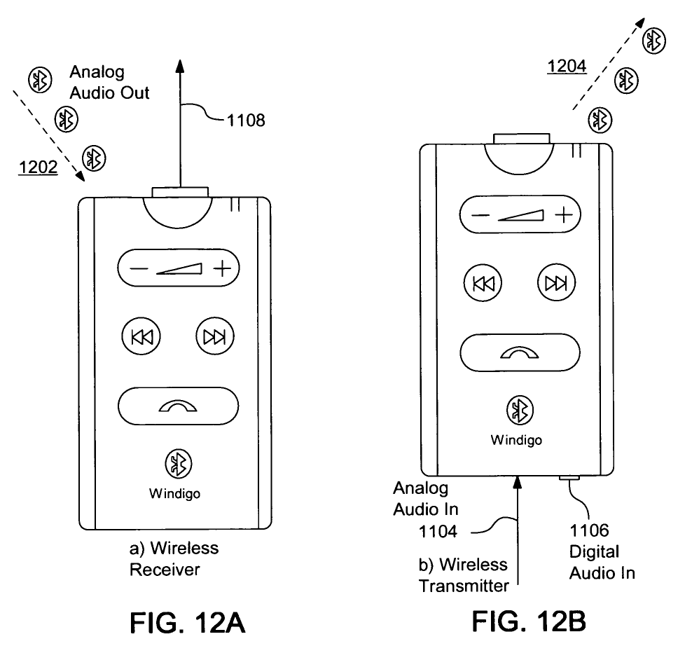

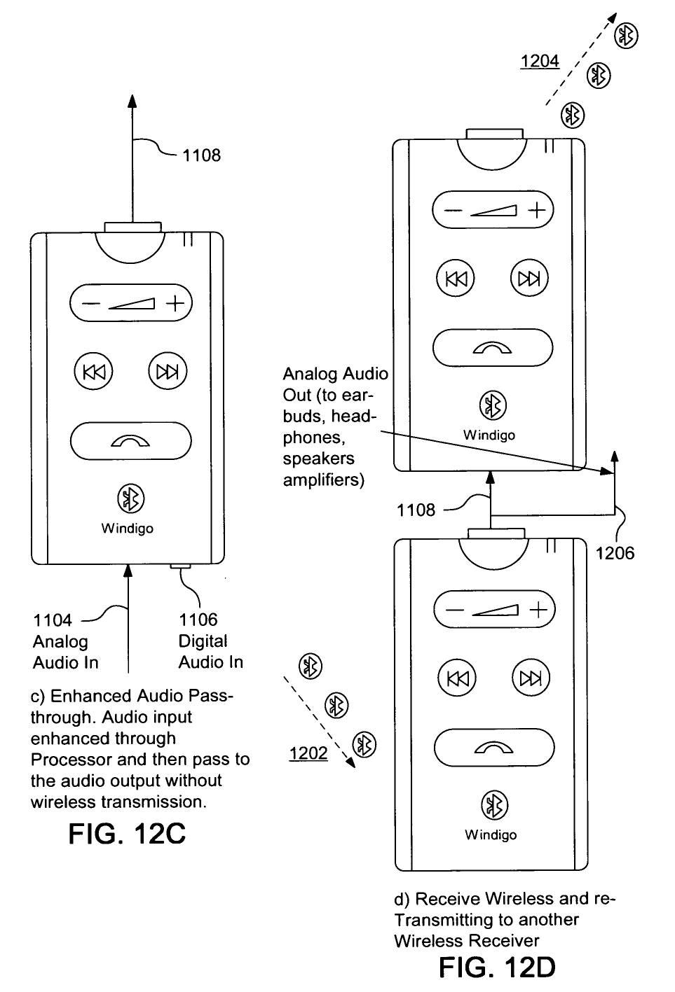

FIG. 12A depicts the wireless device 1100 functioning as a wireless receiver in accordance with an embodiment of the invention. As shown, a

FIG. 12A depicts the wireless device 1100 functioning as a wireless receiver in accordance with an embodiment of the invention. As shown, a wireless audio or voice signal 1202 is received by the device 1100. The device 1100 may, for example, transmit the audio or voice signal via the analog output port 1108 (or alternatively by wireless transmission).

FIG. 12B depicts the wireless device 1100 functioning as a wireless transmitter in accordance with an embodiment of the invention. As shown, an audio signal (either analog 1104 or digital 1106) may be received by the device 1100. The device 1100 may, for example, transmit the audio signal by wireless transmission 1204.

FIG. 12C depicts the wireless device 1100 functioning as a non-wireless audio pass-through device in accordance with an embodiment of the invention. As shown, an audio signal (either analog 1104 or digital 1106) may be received by the device 1100. The device 1100 may, for example, transmit or pass-through the audio signal via the analog output port 1108. Within the device 1100, the audio signal may be enhanced by use of a processor within the device 1100 before the audio signal is transmitted or passed-through. For example, the audio signal may be processed by audio algorithms for real/virtual sound.

FIG. 12D depicts the wireless device 1100 functioning to receive wireless audio and re-transmit the audio signal to another wireless device 1100 in accordance with an embodiment of the invention. As shown, a wireless audio or voice signal 1202 is received by the device 1100. The device 1100 may, for example, transmit the audio or voice signal via the analog output port 1108. In the illustrated configuration, the analog audio output 1108 may be sent to both another wireless device 1100 and to an audio listening device 1206 (for example, to ear-buds, head-phones, or speaker amplifiers). The other wireless device 1100 may transmit the audio or voice signal, for example, by wireless transmission 1204.

### CONCLUSION

The above-description discloses advantageous methods and apparatus for wireless stereo audio. Among other embodiments, aspects and features, it discloses the following.
1. A stereo head-set with a removable ear-piece portion, or designed to accept an additional transmitter.
2. An audio transmitter included or that can fit into the removable ear-piece portion, connected to the digital and/or analog outputs of the wireless receiver of the stereo headset.
3. The audio transmitter may be paired to another stereo headset receiver that can receive reliable audio.
4. This can be repeated for additional stereo headsets, with multiple listeners able to listen to a single audio source with good audio quality, particularly if the transmitter on each ear-piece receives digital audio from the receiver of the same ear-piece.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A method of wireless audio transmission to multiple wireless headsets, the method comprising:
transmitting an audio signal from an initial wireless audio transmitter to a wireless receiver in a first wireless headset;
transferring the audio signal from the wireless receiver in the first wireless headset to a wireless transmitter in the first wireless headset; and
transmitting the audio signal from the wireless transmitter in the first wireless headset to a wireless receiver in a second wireless headset.

2. A method of wireless audio transmission to multiple wireless headsets, the method comprising wireless transmission of an audio signal to a series of wireless headsets in a daisy chain manner.

3. A wireless headset, the headset comprising:
a wireless receiver configured to receive an audio signal; and
a wireless transmitter configured to re-transmit the audio signal or version thereof.

4. A detachable ear piece for a wireless headset, wherein the detachable ear piece comprises a wireless transmitter for transmission of an audio signal.

5. A wireless headset, the headset comprising:
a wireless receiver configured to receive an audio signal; and
an audio output port.

6. The wireless headset of claim 5, wherein the headset further comprises an audio input port such that the headset is operable in wired or wireless modes.

7. A wireless headset comprising:
a wireless receiver electronics configured to receive an audio signal; and
a mini-speaker coupled to the wireless receiver electronics; and
control circuitry configured such that when an incoming call is received on a cell phone associated with the wireless headset, a ring tone or vibration is emitted from the mini-speaker in the headset.

8. A wireless headset comprising:
a wireless receiver electronics configured to receive a first audio signal;
an ear cup;
a microphone coupled to the ear cup;
noise cancellation circuitry coupled to receive a signal from the microphone and configured to generate a second audio signal therefrom; and
voice enhancement circuitry coupled to receive the signal from the microphone and configured to generate a third audio signal therefrom.

9. A method of providing a modified audio signal to a user using a headset, the method comprising
receiving an audio signal;
receiving a signal from a microphone relating to external sounds picked up by the microphone;
generating a noise-cancellation signal from the signal from the microphone;
generating a voice-enhancement signal from the signal from the microphone; and
forming the modified audio signal using any number of signals from a group of signals including the audio signal, the noise-cancellation signal, and the voice-enhancement signal.

10. A wireless device configured to receive an audio or voice signal and to re-transmit the signal.

11. The wireless device of claim 10, further comprising a processor for enhancing the signal prior to re-transmission.

12. The wireless device of claim 10, further comprising both a wireless receiver and at least one audio input port.

13. The wireless device of claim 12, further comprising both a wireless transmitter and at least one audio output port.

14. The wireless device of claim 13, further comprising a clip for attachment of the device.
